(19) United States
(12) Patent Application Publication
(10) Pub. No.: US 2014/0360957 A1
(43) Pub. Date: Dec. 11, 2014

(54) ADJUSTABLE TRUCK TRAILER REMOVABLE RACK

(71) Applicant: Randy Himes, Granger, IN (US)

(72) Inventor: Randy Himes, Granger, IN (US)

(21) Appl. No.: 13/912,179

(22) Filed: Jun. 6, 2013

(51) Int. Cl. B60P 7/08

(52) U.S. Cl. CPC B60P 7/0815
USPC 211/87.01

(57) ABSTRACT

An adjustable rack having a first member that slidably engages with a second member; both members having an extension 28 and a cut-out 26 that removably engages with an E-track.

### RELATED APPLICATIONS

This is a continuation in part patent application, which claims priority on U.S. patent application Ser. No. 13/252,184 filed on Oct. 3, 2011, which is a continuation in part application, claiming priority on U.S. patent application Ser. No. 11/939,531, filed on Nov. 13, 2007.

### BACKGROUND OF THE INVENTION

This invention relates to a rack that may be attached to an E-track, particularly vertically oriented E-tracks. This rack may be adjustable in length.

Enclosed trailers use E-tracks with E-track straps to secure items therebetween, and adjacent to the sidewalls of the trailer. Before the present invention, E-track straps were used. These are straps made of fabric or cloth that can be secured or tied to the E-tracks. They are often not adjusted to the correct length, thus this looseness does not properly secure beams or cargo. Also, it may be difficult to tighten a strap that is above ones shoulders.

As can be seen, there is a need for a rigid rack that attaches to E-tracks to hold items in trailers.

### SUMMARY OF THE INVENTION

An aspect of the present invention is a rack (10), comprising: a member (20); said member (20) having a clip portion (70); said clip portion (70) having a wall (74), said wall (74) having a bottom indent (80) and a top indent (90); whereby said top indent (90) and said bottom indent (80) are capable of being removably secured to an E-track.

Another aspect is a rack (10) for an E-track, comprising: a member (20); said member (20) having a clip portion (70); said clip portion (70) having a wall (74), said wall (74) having a bottom indent (80) and a top indent (90); whereby said top indent (90) and said bottom indent (80) are capable of being removably secured to an E-track.

Yet another aspect is a method of using a rack (10) with and E-track, comprising the steps of: installing of upper rack (200), positioning cargo (300), and installing a lower rack (400).

These and other features, aspects and advantages of the present invention will become better understood with reference to the following drawings, description and claims.

### BRIEF DESCRIPTION OF THE DRAWINGS

FIG. 1 is a pictorial view of an exemplary embodiment of the present invention;

FIG. 2 is a another pictorial view of an exemplary embodiment of the present invention;

FIG. 3 is a pictorial view of an exemplary embodiment of a top view of the clip portion;

FIG. 4 is a view of an exemplary embodiment of the first member of present invention;

FIG. 5 is a view of an exemplary embodiment of the edge bracket plate of the present invention;

FIG. 6 is an exemplary embodiment of a center bracket plate of the present invention, and

FIG. 7 is a pictorial view of a link of the present invention.

### REFERENCE NUMERALS

10 rack
20 first member
25 second member
26 cut-out
28 extension
30 first side
40 second side
50 angle between the first side and the member
60 aperture
79 clip portion
71 clip portion proximal side
72 clip portion distal side
74 wall
76 wall spring receiving member
80 bottom indent
90 top indent
100 clip
102 clip spring receiving member
104 shoulder
106 neck
110 slot
120 pivot
130 spring
140 reinforced portion
150 distance between top indent 90 and bottom indent 80
160 height of member 20
170 depth of top indent 90
180 recess of bottom indent 80
190 width of top indent 90
195 width of bottom indent 80
196 edge bracket plate
197 center bracket plate
198 link
200 installing of upper rack
300 positioning cargo
400 installing of lower rack
500 removing of lower rack

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

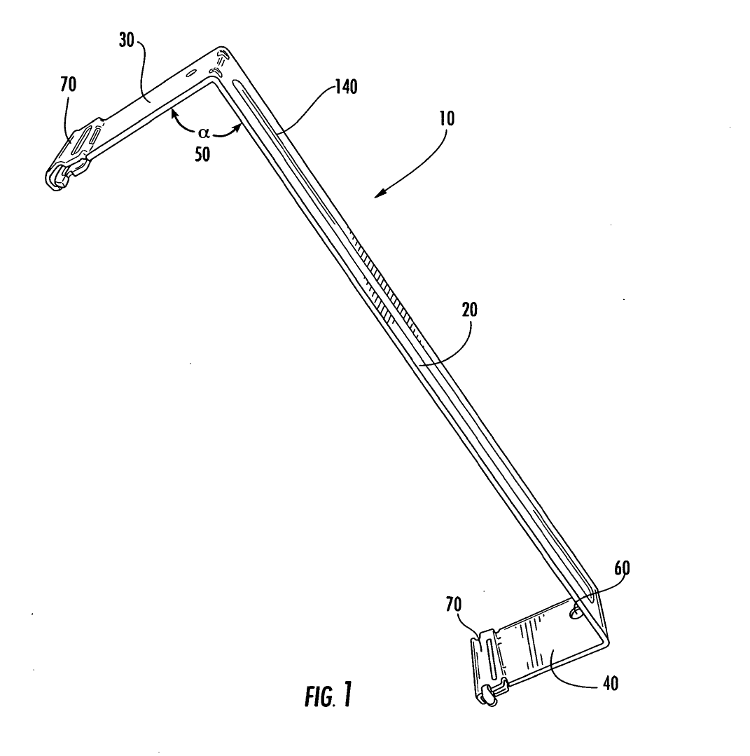

FIG. 1 illustrates an exemplary embodiment of the present invention, referred to as a rack 10. The rack 10 is comprised of a member 20 having two opposed clip portions 70. The member 20 may have a first side 30 and a second side 40. In one exemplary embodiment, the first side 30 and second side 40 may be substantially parallel with respect to the other. In one exemplary embodiment, the member 20 may be substantially perpendicular with at least one of the first side 30 or the second side 40, in which case the angle between the member 20 and at least one of either the first side 30 or second side 40 may be 90°. This angle is represented in FIG. 1 as α. In other embodiments this angle may be something other than 90°. An aperture 60 may be disposed in the member 20, or the aperture 60 may be disposed in at least one of the first side 30 or second side 40.

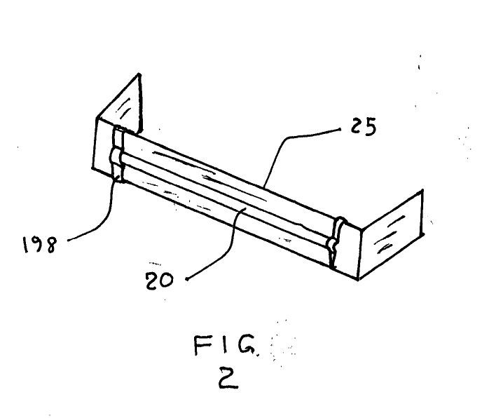

FIG. 2 illustrates an exemplary embodiment of an embodiment of a first member 20 and the first member's 20 slidable connection to a second member 25. A link 198 clips over the first member 20 and a portion of the second member 25 so that the first member 20 is in slidabley engaged with the second member 25. a clip portion 70. The clip portion 70 may have a bottom indent 80, a top indent 90, and a clip 100. The clip 100 pivots about a pivot 120. The clip portion 70 may have a slot 110. The clip portion 70 may have a clip portion proximal side 71, and a clip portion distal side 72, which may be further from the member 20 than the clip portion proximal side 71. The clip portion 70 may have a wall 74 that extends from clip portion proximal side 71 to the clip portion distal side 72.

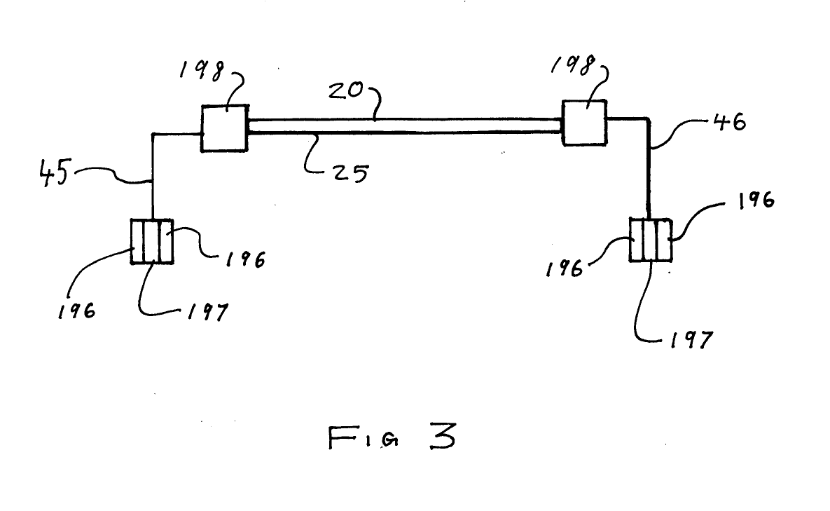

As best seen in FIG. 3, illustrates the first member 20 may be slidably disposed in front of the second member 25 by the first member 20 and second member 25 both being slidably engaged to each other by sliding within clips 198. The first member 20 extends rightwardly to a first member arm 46 that extends downwardly from the first member 20.

Also, the second member 25 may extend leftwardly to a second member arm 45 that extends downwardly from the second member arm 45.

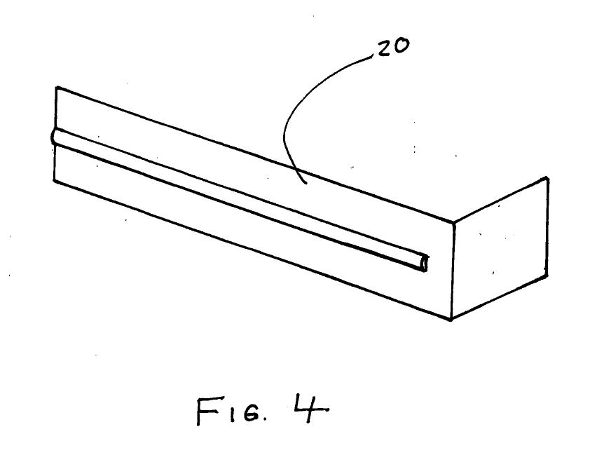

FIGS. 4 and 5 illustrate one exemplary embodiment of how the clip 100 may be pivotally secured to the clip portion 70 by a pivot 120. This pivot 120 may be a rivet, or other member. A spring 130 may be secured at one end to a wall spring receiving member 76. The wall spring receiving member 76 may be a cylindrical shaped extension. The spring 130 may be able to fit over the wall spring receiving member 76 at one end; and at an opposed end the spring 130 may be received by a clip spring receiving member 102. The clip spring receiving member 102 may be an extension extending from the clip 100 to the direction of the wall spring receiving member 76, so that the spring 130 may be biasly disposed on both the wall spring receiving member 76 and the clip spring receiving member 102 to bias the clip 100 towards the clip portion distal side 72.

As illustrated in FIG. 4, the clip 100 may have a shoulder 104 that may contact the clip portion distal side 72 when the clip 100 is positioned in what is referred to herein as a “closed” position. As illustrated in FIG. 5, a neck 106 may extend upwardly from the shoulder 104. The neck 106 may be pulled to place the clip 100 or shoulder 104 in an “open” position.

A slot 110 may be disposed near the clip portion (70) or in the clip portion (70).

In one exemplary embodiment, the member may have a reinforced portion 140 to increase the strength of the member 20. The reinforced portion 140 may be a curved radii that expands the length of the present invention rack 10.

In one exemplary embodiment, the first side 30 or second side 40 may have an aperture 60. The aperture may be used to hang things from.

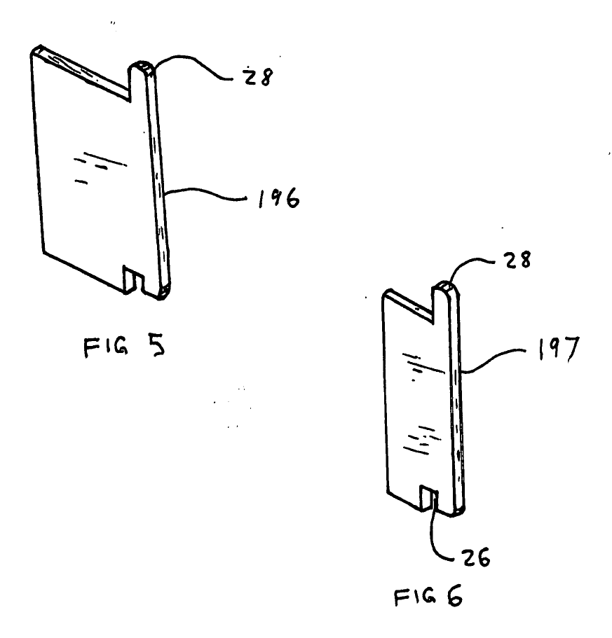

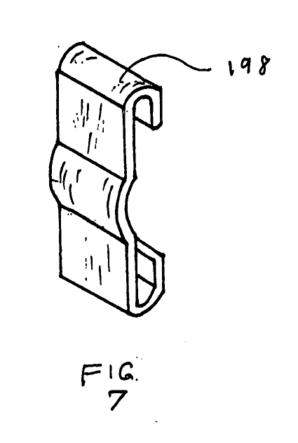

FIG. 6 illustrates one method of use of the present invention 10. The clip 100 can be “opened” by pulling the neck 106 toward the clip portion proximal side 71, then the rack 10 may be installed on a slot of an E-track by positioning the top indent portion 90 around the respective portion, or top of the slot, of the E-track, then the bottom indent 80 may rest on the bottom of the E-track slot. This step may be called the installing of upper rack 200. The next step may be positioning cargo 300. FIG. 6 illustrates the use of two racks 10 to secure bars, such as deck bars. Then deck bars or cargo may be positioned 300 between the rack 10 and the trailer wall. The third step may be installing a lower rack 400. Then, to access cargo, one can execute the step of removing the lower rack 500.

The dimensions of the rack 10 may vary. For example the beam 10 may be a variety of lengths to accommodate for different positions of E-track placement. In one embodiment, the clip portions 70 are disposed at a distance of 24 inches. This embodiment may be used with vertically oriented E-tracks being disposed about 24 inches apart. In another embodiment, the clip portions 70 are disposed at a distance of 32 inches. This embodiment may be used with vertically oriented E-tracks being disposed about 32 inches apart.

In one exemplary embodiment, the first side 30, and the second side 40 are about 5 5/16 inches in length. In another embodiment, hinges could be positioned between the member 20 and at least one of either the first side 30 and the second side 40, so that it would be easier to place the clips in the E-tracks. Alternatively, a hinge or pivot mechanism may be disposed between the clip portion 70 and at least one of the first side 30 and/or second side 40, which would allow the clip portion 70 to hinge or pivot with respect to the first side 30 or second side 40.

The rack 10 can be comprised of a variety of cross sectional shapes and configurations.

In one exemplary embodiment, the shortest distance 150 between the top indent 90 and the bottom indent 80 is about 2 ⅛ inches. In one exemplary embodiment, the height 160 of the member is about 2 9/16 inches. In one exemplary embodiment the depth 170 of the top indent 90 is about ⅜ of an inch. In one exemplary embodiment, the bottom indent 80 is recessed 180 about 3/16 of an inch. In one exemplary embodiment the distance across 190 the top indent 90 is about ⅜ of an inch. In one embodiment the distance across 195 the bottom indent 80 is about ¼ of an inch.

This rack 10 may have additional applications beyond use in trailer E-tracks.

In one exemplary embodiment the rack 10 may be comprised of metal or a metal allow. However other materials that can form a rigid structure can also be used, such as steel, composites, plastics, aluminum, or wood.

A rack 10 of the present invention may be formed with a variety of processes, such as the extrusion process. Further, the rack 10 may be formed by a press bending process or a stretch forming process. Other methods may also be used to make the present inventions rack 10.

FIG. 7 illustrates an embodiment of an link 198 of the present invention. The link 198 may receive both the first member 20 and the second member 20 so that the first member is slidably engaged with respect to the second member 25. As illustrated in FIGS. 7 and 8, the adjustable rack 10 may have a first member 20 slidably disposed to a second member 25. Two links 198 may be secured to the first member 20, and the second member 25 to prevent the first member 20 from sliding out of the second member 25. FIG. 12 illustrates a link 198, which may be a c-shaped member.

FIG. 5 illustrates one embodiment of an edge bracket 196 that is capable of engaging with the E-tracks of the truck. Between both edge bracket plates 196 may be a center bracket plate 197.

Both the edge bracket plate 196 and the center bracket plate 197 may have a cut-out 20 which may be similar as the bottom indent 80.

FIG. 6 illustrates an embodiment of the center bracket plate 197. The center bracket plate 197 may have an extension 28 extending upwardly therefrom, and the center bracket plate 197 may have a cut-out 26. The cut-out 26 may be a square cut and may be disposed between the front and the back of the center bracket plate 197.

It should be understood, of course, that the foregoing relates to exemplary embodiments of the invention and that modifications may be made without departing from the spirit and scope of the invention as set forth in the following claims. This listing of claims shall replace all other versions, and listings, of the claims in the application.

This listing of claims shall replace all other versions, and listings, of the claims in the application.

I claim:

1. an adjustable removable rack for an E-track (10), comprising:
a first member (20) having an arm (45) extending from said first member, said arm (45) substantially perpendicular with respect to said first member (20);
a second member (25) slidably disposed on said first member (20) said second member having an arm (46) extending from said second member (25) in the same direction as said arm (45) that extends from said first member (20);
each of said arm (45), (46) having an edge bracket plate (196) secured thereto;
said edge bracket plate (196) having an extension (28) extending upwardly, same edge bracket plate (196) having a cut-out (26) on said edge bracket (196) bottom side so that the cut-out (26) can rest on an edge of an E-track;
whereby said extension extends upwardly (28) and said cut-out extends upwardly (26) are capable of being removably secured to an E-track.

2. The rack of claim 1, further comprising a center bracket plate (197) disposed between an edge bracket plates (196) on each side, said bracket plate (197) having an extension 28 that extends upwardly, and a cut-out (26) that extends upwardly, that are capable of being removably secured to an E-track.

3. The rack of claim 1, further comprising a link (198) disposed on at least one of either said first member (20) or said second member (25) to prevent said first member (20) from disengaging from said second member (25).
